(19) United States
(12) Patent Application Publication
(10) Pub. No.: US 2025/0293941 A1
(43) Pub. Date: Sep. 18, 2025

(54) INTENT BASED AUTOMATION FOR PREDICTIVE ROUTE PERFORMANCE

(71) Applicant: Telefonaktiebolaget LM Ericsson (publ), Stockholm (SE)

(72) Inventors: Erik WESTERBERG, Enskede (SE); Gyan RANJAN, Milpitas, CA (US); Ilaria BRUNELLI, Prosper, TX (US); Arthur Richard BRISEBOIS, Westport Point, MA (US); Stephen TERRILL, Madrid (ES); Alejandro Gil CASTELLANOS, Snoqualmie, WA (US)

(21) Appl. No.: 18/860,202

(22) PCT Filed: Apr. 25, 2023
(86) PCT No.: PCT/IB2023/054230

§ 371 Date: Oct. 25, 2024

Related U.S. Application Data
(60) Provisional application No. 63/334,374, filed on Apr. 25, 2022.

(51) Int. Cl. H04L 41/147; H04L 45/302

(52) U.S. Cl. CPC H04L 41/147; H04L 45/306

(57) ABSTRACT

A network node in a communications network can determine a service level prediction. The network node can further generate an intent based on the service level prediction. The network node can further assign the intent to a set of intents used by the communications network.

### TECHNICAL FIELD

The present disclosure is related to wireless communication systems and more particularly to intent based automation for predictive route performance.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

Intent-based automation (“IBA”) is a technology being developed for operating a system not by means of configuration and imperative policies, but by defining objectives the system shall reach and relative priorities between the objectives. Intent-based automation has been heavily discussed in the context of networking and also in the context of workload placement in data centers. Recently intent-based automation has been proposed as a promising technology for management of mobile networks.

To exemplify the IBA technology in a telecom context, consider the problem of providing a cellular service to two users in an area. As there is a finite set of spectrum and base-stations in the area, there is competition between the users for radio-channel capacity and a prioritization between the users has to be done. Traditionally this is done by setting a set of configuration parameters that are associated with rules and behavior in the radio network algorithms. Such parameters include handover parameters, load-balancing thresholds, and relative scheduling priorities. It has traditionally been the mobile operator's operations staff that has been given the complex task of identifying how these often conflicting configuration parameters should be set to get the wanted behavior of the system. In the same scenario the intent-based automation would mean that the operations team program the network not with configuration parameters but with intents. In some examples, an intent can be that the average downlink throughput of the first user group should be no less than 10 Mbps while a second intent could be that the average downlink throughput for the second user group should be no less than 5 Mbps. In additional or alternative examples, the operations team can program the network with a priority intent, stating that when both intents above can not be met simultaneously, then the network shall prioritize the fulfillment of the first intent. The IBA-capable network then uses the intents as objectives to reach its automated allocation of radio resources to the users, using whatever tools it has (e.g., beam forming, scheduling, handoffs, and load balancing).

### SUMMARY

According to some embodiments, a method of operating a network node in a communications network is provided. The method includes determining a service level prediction. The method further includes generating an intent based on the service level prediction. The method further includes assigning the intent to a set of intents used by the communications network.

According to other embodiments, a method of operating a communication device in a communications network is provided. The method includes requesting a service level prediction from a network node in the communications network. The method further includes receiving the service level prediction from the network node. The method further includes performing an action based on the service level prediction.

According to other embodiments, a communication device, network node, computer program, computer program product, host, system, or non-transitory computer readable medium is provided to perform at least one of the above methods.

Certain embodiments may provide one or more of the following technical advantages. In some embodiments, the accuracy and reliability of KPI predictions are improved. In some examples, this can enable use-cases that are otherwise out of reach and can enable traditional KPI predictions to be used in wider geographies where historical data is not sufficient to make meaningful predictions. In additional or alternative examples, this mitigates the negative effects on KPI predictions that can come from rare events (e.g., temporary traffic peaks due to unexpected network usage or radio site failure).

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is a block diagram illustrating an example of an intent-based automation (“IBA”) system for intent-based automation of route predictions in accordance with some embodiments;

FIG. 3 is a signal flow diagram illustrating an example of operations performed by the IBA system of FIG. 2 in accordance with some embodiments;

FIG. 4 is a block diagram illustrating an example of a system for service-level agreement (“SLA”) notification that assured predictive bandwidth cannot be met) in accordance with some embodiments;

FIGS. 5-6 are signal flow diagrams illustrating examples of SLA notification that assured predictive bandwidth cannot be met in accordance with some embodiments;

FIG. 7 is a block diagram illustrating an example of a system for assuring bandwidth prediction using 3^{rd} Generation Partnership Project (“3GPP”) in accordance with some embodiments;

FIG. 8 is a signal flow diagram illustrating an example of operations performed by the system in FIG. 7 for ensuring the predicted bandwidth in accordance with some embodiments;

FIG. 9 is a block diagram illustrating an example of a system for assuring bandwidth prediction for a route in accordance with some embodiments;

FIGS. 10-11 are signal flow diagrams illustrating examples of operations for predicting bandwidth for a user, and area, or a route in accordance with some embodiments;

FIGS. 12-14 are flow charts illustrating examples of operations performed by a network node in accordance with some embodiments;

FIG. 15 is a flow chart illustrating an example of operations performed by a communication device in accordance with some embodiments;

FIG. 16 is a block diagram of a communication system in accordance with some embodiments;

FIG. 17 is a block diagram of a user equipment in accordance with some embodiments;

FIG. 18 is a block diagram of a network node in accordance with some embodiments;

FIG. 19 is a block diagram of a host computer communicating with a user equipment in accordance with some embodiments;

FIG. 20 is a block diagram of a virtualization environment in accordance with some embodiments; and

FIG. 21 is a block diagram of a host computer communicating via a base station with a user equipment over a partially wireless connection in accordance with some embodiments in accordance with some embodiments.

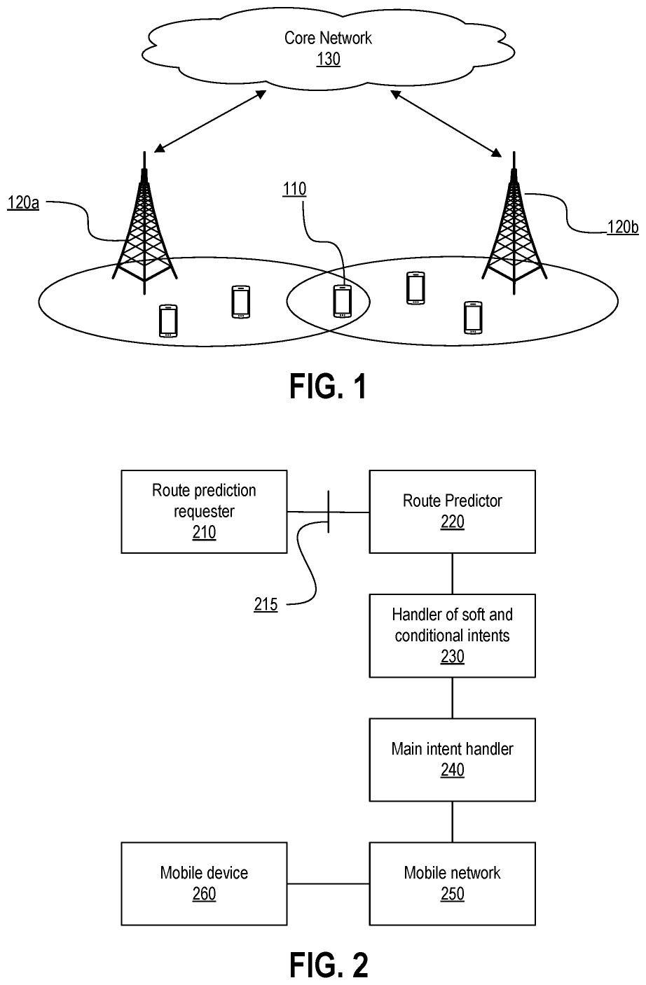

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Cellular networks can be stochastic in nature in the sense that the quality of any service to an individual user depends on the location of that user, proximity to radio towers, time of the day, and which other users in the area are active and how much radio resources they consume. While this best effort characteristics can be acceptable for some use-cases and services (e.g., general web browsing and some internet consumer services), there is a set of services that benefit from a guaranteed service level. One example is a remotely operated vehicle that can only work in situations where acceptable real-time video streams can be maintained between the vehicle and the remote driver. Though stochastic in nature, the behavior of the radio networks is far from completely random. Geographies close to radio towers have better radio links than places indoors or far from radio sites, and thus generally higher service levels can be provided in such places. The impairment on the service of a single user as a result of other user's behavior follows certain patterns as a consequence of patterns in human mobility, behavioral patterns, and daily reoccurring traffic load variations. Route prediction technology uses that hidden patterns in user mobility and cell phone usage to predict the performance an individual user can expect along a certain route through, for example, a city. Based on such predictions the route prediction technology can offer various types of information over an application programming interface (“API”) to applications that like to understand the expected mobile network service level when travelling along that route.

In the example of the remotely operated vehicle, the vehicle operator may want to remotely drive the vehicle from location A to location B. In one implementation of the route prediction technology the use-case would follow the following logic.

First, the remote vehicle actor submits the start position A and the destination position B to the route predictor to define the route.

Second, the route predictor estimates the service level the remote vehicle would have if moving along a path between points A and B. For example, the route predictor can estimate uplink throughput to vary between 5 Mbps and 8 Mbps over the route.

Third, in this example, the route predictor is implemented to provide over the API estimates of uplink throughput in 5 Mbps intervals. According to its design to report in 5 Mbps intervals, the route predictor would respond to the remote vehicle actor with the prediction “The uplink throughput on the route from location A to location B is predicted to be in the interval 5 Mbps-10 Mbps.”

The three operations described above are an example of one specific implementation of the route prediction technology. In other implementations the prediction can related to latency, downlink throughput, and more generally to any measurable service performance metric related to the mobile network service. The location input from the remote vehicle agent can also be both simpler (e.g., just a stationary position) and more advanced (e.g., a route A to B via intermediate positions C, D, and E, or a time variable associated with the route like “route traversed between 11.30 am and 12.00 am). Also, the remote vehicle agent in the example above can generically be any entity authorized to access the route prediction API.

The Route Prediction technology is a special case of a broader field of general Key performance indicator (“KPI”) prediction. Just like the mobile network performance for an individual user can vary along a geographical route, any relevant KPI typically vary over geography and time. These KPIs can be, for example, the average latency for all users in an area, the uplink throughput for a set of fixed security cameras, the energy consumption for a base-station site, and more. Just as there are use-cases where accurate predictions of the throughput along a route is useful, there are use-cases where precise predictions or any other KPI has substantial value. Although some embodiments herein are described in the context of route prediction, the innovations are applicable to the broader idea of using IBA for any KPI description.

There currently exist certain challenges. In some examples, existing Route prediction technology has limited accuracy in its predictions. The predictions are based on patterns in traffic and mobility that are in turn based on historical data and user behavior. In some examples, though traffic patterns suggest that normally a route in the evening has low traffic levels (and hence the route prediction is that, for example, 5 Mbps can be maintained from point A to point B), a few minutes later a bus full of youngsters watching videos can enter a cell associated with the route and cause congestion that pushes down the throughput for the remote vehicle connections. In another example, a pico-cell along the route that normally provides high bitrates could, this particular morning, not be active due to maintenance, or put in sleep mode because traffic levels in the local area are much lower than a normal Monday morning.

In some examples, the predictions are just predictions based on historical data. As a result, these predictions suffice to provide predictions with good enough accuracy to be useful. However, in many situations, the accuracy and reliability of the predictions are too low be useful. As historical data inherently does not have a perfect correlation to future events, the existing technology is incapable of improving the accuracy beyond certain levels. This limits the applicability of route prediction technology, and more generally the applicability of predictive KPIs.

Certain aspects of the disclosure and their embodiments may provide solutions to these or other challenges. Various embodiments herein propose to use Intent-based automation to stabilize the predictions of KPIs and improve the accuracy of those predictions. In some embodiments, the mobile network is made an active part in a route prediction solution by assigning a temporary intent to the prediction that enables the network to use its resources to make the prediction come true. In additional or alternative embodiments, the intents are classified into groups and assigned priorities so that other KPIs in the system are impacted only within bounds (e.g., within the same group), and in such a way that business priorities are still met.

In some embodiments, operations are provided for intent based automation for predictive route performance. The operations can include an outside agent (e.g., a remote vehicle operator) using a Route Prediction API to ask the network to find a route between locations A and B where 5 Mbps can be maintained over the next 30 minutes. The operations can further include the network using existing technology to find a path that, based on historical data, is expected to serve the remote vehicle with 5 Mbps. The operations can further include the route being reported back to the outside agent.

In additional or alternative embodiments, the operations include the network issuing a soft and conditioned intent of a minimum service level of 5 Mbps for this vehicle. In some examples, the network issues the soft and conditioned intent to itself.

In additional or alternative embodiments, the operations include the IBA-capable network including the soft and conditioned intent in its set of intents. In some examples, including the soft and conditioned intent in the set of intents gives a certain priority to maintaining the 5 Mbps to the remotely operated vehicle along the route for the given time period. As a result, if a situation occurs along the route where (due to competition for resources) the service level to the remotely operated vehicle under normal intent operation would fall under 5 Mbps (sometimes referred to as a prediction violation), the new soft and conditioned intent will kick in and the system will temporarily up-prioritize the vehicle's traffic.

In additional or alternative embodiments, the operations include the system removing the soft and conditioned intent from its set of intents in response to a trigger event. In the above examples, the trigger event can include the remotely operated vehicle reaching its destination point B, or the 30-minute prediction period having elapsed.

In additional or alternative embodiments, the operations include the system logging and storing the performance data along the route, including information on if and when the intent was used to maintain the prediction, to serve as input to the route prediction technology as it derives future predictions.

The term “soft and conditioned intent” is described below. In some examples, the intent is soft in the sense that it should not be interpreted as changing the overall priority of the remotely operated vehicle. In one embodiment the priority given to the intent would not be higher than the intent associated with devices of higher business importance. Rather it allows for a temporary prioritization relative other users in the same category (e.g., best effort category) for the purpose of making the prediction come true. In additional or alternative examples, the content is soft in the sense that capacity can be “given back” to other users when there is plenty of resources. In this way it trades capacity within its own base priority class over time. In some examples, the intent is conditioned in that it is only used by the system as long as the remotely operated vehicle follows the route over which the prediction was made. Should the vehicle deviate from the route, the prediction is no longer relevant, and the intent is suspended until the vehicle enters the route again. And after the end of the prediction time the soft and conditioned intent is deleted.

Various embodiments described herein use “soft and conditioned intents” to stabilize and improve the accuracy of KPI prediction. In some embodiments, an IBA-capable system creates, uses, and deletes such soft and conditioned intents in its resource assignment. Compared to known IBA technology, the concept and usage of soft and conditioned intents are novel and can solve the problem of accuracy in predicting KPIs, in particular predictive routes.

FIG. 2 illustrates a block diagram of an example of an intent-based automation (“IBA”) system for intent-based automation of route prediction.

The prediction requester 210 is an entity capable of requesting service level predictions associated with a device along a route via the Route Predictor API 215. The prediction requester 210 also has the capability to receive and understand a prediction over the same API 215 as provided by the route predictor 220.

The route predictor 220 is an entity capable of receiving requests for service level predictions along a route via the Route Predictor API 215. The route predicter 220 has the capability to estimate the service level along the route and communicate back a service level prediction over said API 215 to the Route prediction requester 210. Further the route predictor 220 is capable of sending the route, the device identity, and the prediction to the Handler of soft and conditional intents 230.

The handler of soft and conditional intents 230 is capable of receiving and information set containing a device identifier (“ID”), a route, and a service level prediction from the route predictor 220. The handler of soft and conditional intents 230 has the ability to construct an intent based on the device ID, the route, and the service level prediction and send this intent together with the route and the device ID to the main intent handler 240 as soft and conditional intents.

The main intent handler 240 is capable of receiving soft and conditional intents together with device ID and a route from the handler of soft and conditional intents 230. The main intent handler 240 also has the capability to include such soft and conditional intents in its full sets of intents and to assign to it a priority relative other intents. The main intent handler 240 is also capable of associating the soft and conditional intent with the route and modifying the intent or its priority relative to other intents based on the position of the device 260 relative the route.

The mobile network 250 is a general communication network supporting devices over one or several radio links. The mobile network 250 can be a 3^{rd} Generation Partnership Project (“3GPP”) based mobile network, a WiFi network, a satellite communication system, or any other system that provides communication service over a radio link. The mobile network 250 is capable of receiving intents and relative priorities from the main intent handler 240 and assign system resources based on the intents and relative priorities.

The mobile device 260 is an entity capable of communicating with the mobile network 250 over a radio link. The mobile device 260 can be a 3GPP based mobile station, a WiFi equipped entity, a satellite phone, or any other device that can communicate with the mobile network.

In some embodiments (not illustrated), some of the functional blocks can be combined into a single functional block with the sum of the capabilities of the blocks thus combined. In some examples, the handler of soft and conditional intents 230 and the main intent handler 240 can be combined into a single intent handler. In additional or alternative examples, the main intent handler 240 and the mobile network 250 can be combined into a single implementation.

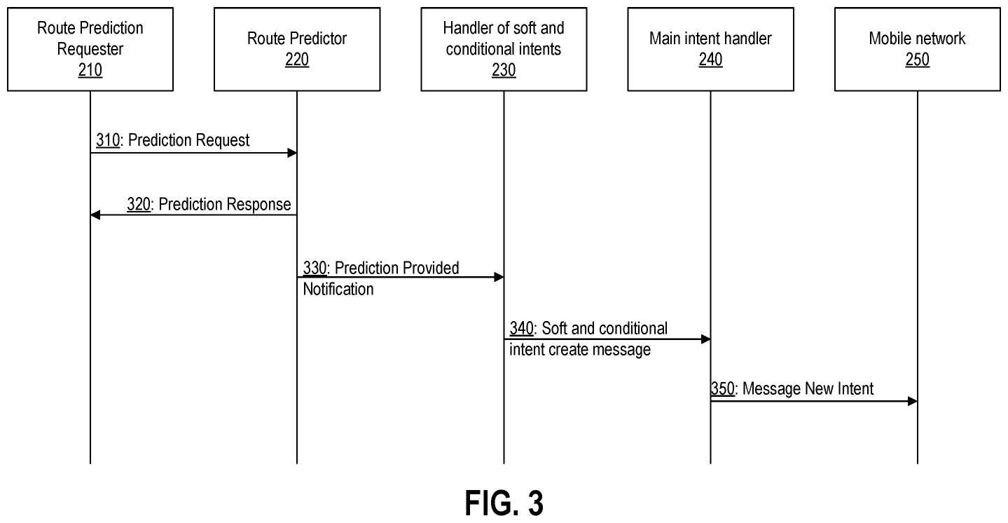

FIG. 3 is a signal flow diagram illustrating an example of operations performed by the intent-based automation (“IBA”) system of FIG. 2 for intent-based automation of route prediction.

At operation 310, the route prediction requester 210 transmits a prediction request to the route predictor 220. In some examples the prediction request includes a route description and a device ID.

At operation 320, the route predictor 220 transmits a prediction response to the route prediction requester 210. In some examples, the prediction response includes the device ID and a service level prediction.

At operation 330, the route predictor 220 transmits a prediction provided notification to the handler of soft and conditional intents 230. In some examples, the prediction provided notification includes the route description, the device ID, and the service level prediction.

At operation 340, the handler of soft and conditional intents 230 transmits a soft and conditional intent create message to the main intent handler 240. In some examples, the soft and conditional intent create message includes the route description, the device ID, and a soft and conditional intent.

At operation 350, the main intent handler 240 transmits a message new intent to the mobile network 250. In some examples, the message new intent includes the device ID, an intent, and a priority of the intent.

The signaling diagram and messages in FIG. 3 represent one embodiment. In additional or alternative embodiments, additional information can be added to each message and there could be additional messages exchanged between the functional blocks (e.g., between the route predictor 220 and the mobile network 250) as part of the service-level estimation process.

Assured bandwidth prediction is described below.

In some examples, applications have the ability to predict the available bandwidth available to users in geographical areas by analyzing the network metrics from the radio access network (“RAN”) as long as they have access to the network metrics/telemetry. This can be from the network elements directly or more commonly from the operations support system (“OSS”) (e.g., a network management system) as an aggregator of the metrics/telemetry. Artificial intelligence (“AI”) and/or machine learning (“ML”) can be used to predict the available bandwidth.

In other examples, 3GPP TS 23.288, section 6.9 (Quality of Service (“QoS”) Sustainability Analytics) describes an ability for a network data analytics function (“NWDAF”) to provide predictions on the sustainable QoS for a location (list of cell-ids or tracking area identities (“TAIs”)). The QoS includes bandwidth.

The above examples describe that application can predict the bandwidth in an area if they receive the required metrics or the network (via the NWDAF) can predict the bandwidth in a given area. In both of the examples above, the consumer of the predicted bandwidth is not notified if the predicted bandwidth cannot be met.

Embodiments associated with a SLA notification of assured bandwidth prediction are described below.

A service-level-agreement (“SLA”) mechanism can inform consumers of SLA breaches and taken actions (which could include a form of financial compensation). However, consumers of the predicted bandwidth are not informed of a breach of the SLA for the predicted bandwidth if the prediction cannot be met.

Various embodiment herein provide that a consumer of a query to an assured prediction is notified if the predicted assured bandwidth cannot be met. In the case of a subscription to the assured bandwidth, this is valid for while the subscription is valid. In the case of a single query, this can require the inclusion of a time period for which the consumer should be informed. In the case of the query including a route, this is valid for the period of time that the UE on the route is traversing the route.

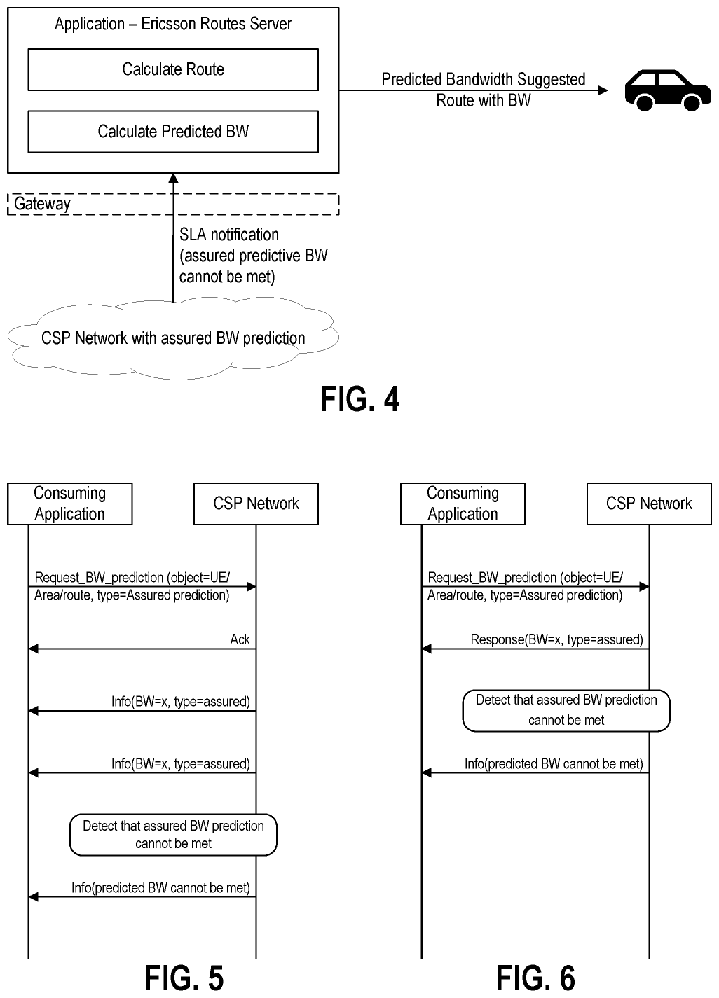

FIG. 4 is a block diagram illustrating an example of a system for SLA notification that assured predictive bandwidth cannot be met). In some embodiments, the consumer of the request for the assured predicted bandwidth is notified if the assured predicted BW can no longer be met, enabling the consumer to take action.

FIG. 5 is a signal flow diagram illustrating an example of operations performed when a consumer is subscribed to the assured predicted bandwidth. The CSP network informs the consumer if the predicted bandwidth cannot be met.

FIG. 6 is a signal flow diagram illustrating an example of operations performed when a consumer makes a single query. In some examples, the query is enhanced to include a time. If during this time, or if during the time that the UE is on the route, the consumer is informed that the predicted bandwidth cannot be met.

Embodiments associated with assuring bandwidth prediction via 3GPP mechanisms are described below. The 3GPP also describes a management data analytics function (“MDAF”), which can provide management analytics insights such as SLS analysis-service experience analysis (e.g., latency throughput), network slice throughput analysis, end-to-end (“E2E”) latency analysis, etc. 3GPP further describes how to increase the priority of the traffic for a user using policy and QoS mechanisms. However, a predicted bandwidth is based on a statistical nature of the radio networks and does not take action to ensure that the prediction is kept accurate.

Various embodiments herein describe an intent function that takes actions to assure that when a prediction is requested, actions can be taken to ensure that the prediction continues to be met. This can be for a UE, an area, or (as described in FIGS. 2-3) a route. In some examples, this can be based on a 3GPP defined mechanism such as temporarily increasing the QoS for a user.

In some embodiments, when a request for bandwidth prediction is requested and soft intents are created, actions can be taken to maximize the possibility that the bandwidth prediction can continue to be met via 3GPP described mechanisms. In particular using the policy control approach described by 3GPP by indicating a 5G QoS identifier (“5QI”) value for assured bandwidth and indicating the bandwidth value. This can be for a user that is in a static location or for a user that is following a described route.

In additional or alternative embodiments, taking actions to ensure that the prediction continues to be met, is that the consumer of the request for the assured predicted bandwidth enjoys the predicted bandwidth.

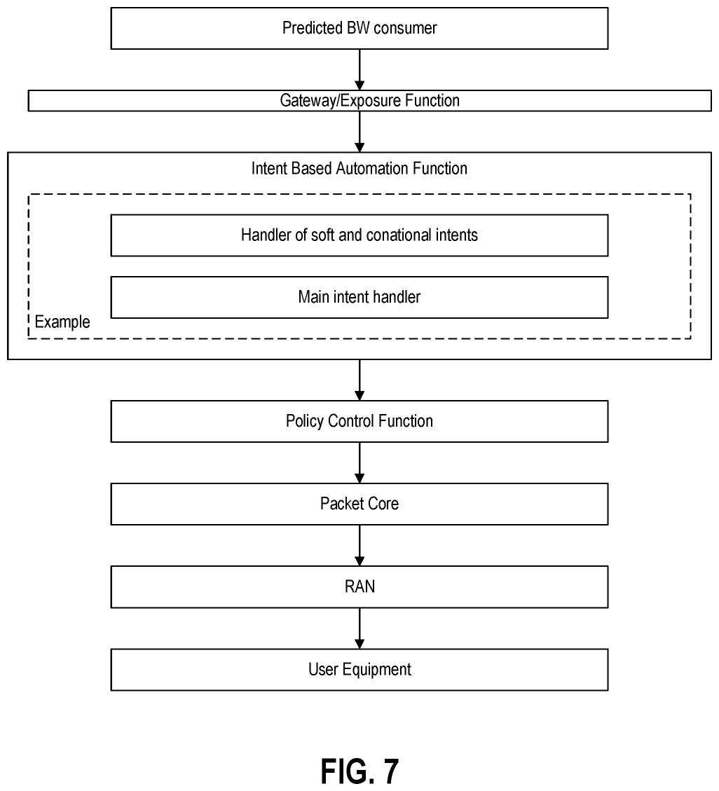

FIG. 7 is a block diagram illustrating an example of a system for assuring bandwidth prediction using 3GPP mechanisms. In some embodiments, a predicted bandwidth consumer requests the predicted bandwidth. The intent based management function knows the possible bandwidth to return. To ensure the predicted bandwidth the intent based management function can request that the Policy Control Function (“PCF”) provide an appropriate 5QI value for the predicated bandwidth. The request can include an indication of the predicted bandwidth. The core network and RAN can work to ensure the predicted bandwidth.

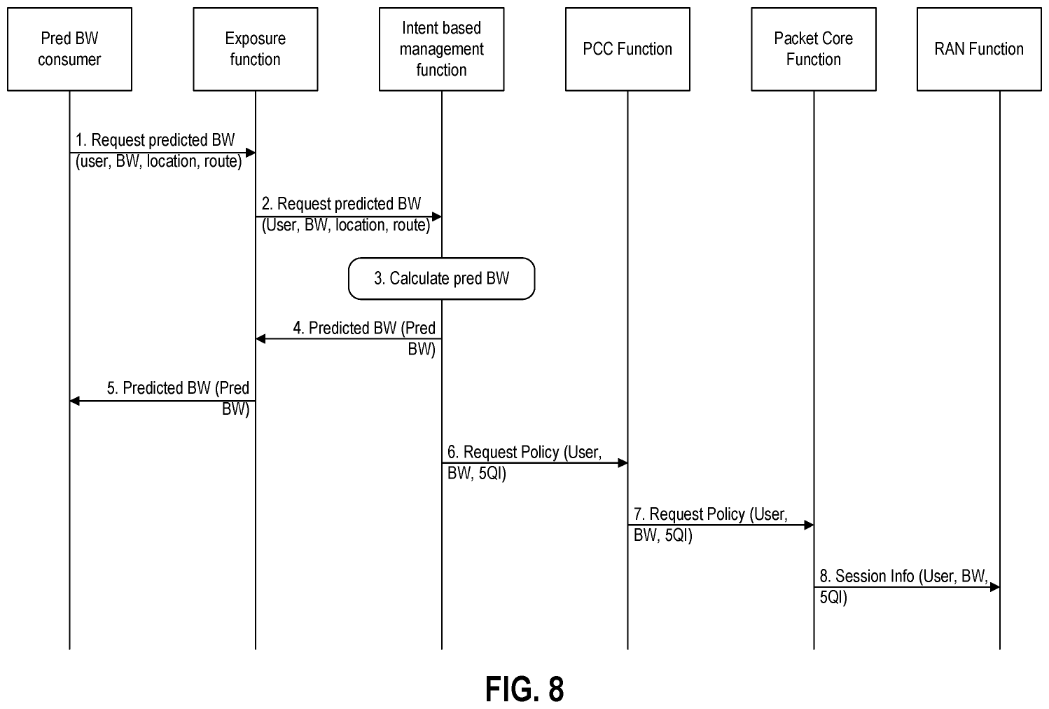

FIG. 8 is a signal flow diagram illustrating an example of operations performed by the system in FIG. 7 for ensuring the predicted bandwidth. In some examples, the predictive bandwidth consumer requests the predicted BW from the exposure function. The exposure function forwards the request to the intent based management function. The intent based management function calculates the sustainable predicted bandwidth. The predicted BW is returned to the exposure function. The exposure function forwards the predicted bandwidth to the predicted bandwidth consumer. The intent based management function requests a policy update to the PCF indicating a 5QI value for predicted bandwidth and the value of the predicted bandwidth. The packet control controller (“PCC”) function performs any subscription check and, if successful, forwards the request to the packet core functions. The packet core functions forwards the request to the RAN function with the 5QI value for predicted bandwidth and the bandwidth value.

Embodiments associated with using assured network bandwidth prediction for routes are described below. Current approaches that determine a predicted bandwidth based on historical/statistical data can be inaccurate due to unexpected events (e.g., events that change the behavior of network users such as roadworks, traffic accidents, changes in weather, concerts, and protests). In addition, current approaches may focus on a current area of a UE rather than a predicted route (sometimes referred to herein as a planned route).

Various embodiments herein describe an application server that consumes the assured bandwidth prediction. In some examples, this removes the need for the application to make its own prediction and increases the confidence in the prediction as it knows the network will take action to ensure the prediction is correct. In additional or alternative examples, the prediction can be made not only on a UE and/or area, but for a UE traversing a described route.

In some embodiments, an application working with assured bandwidth prediction can leverage an increased confidence in the predicted bandwidth offloading the need to provide its own bandwidth prediction functionality which will have a lower confidence level.

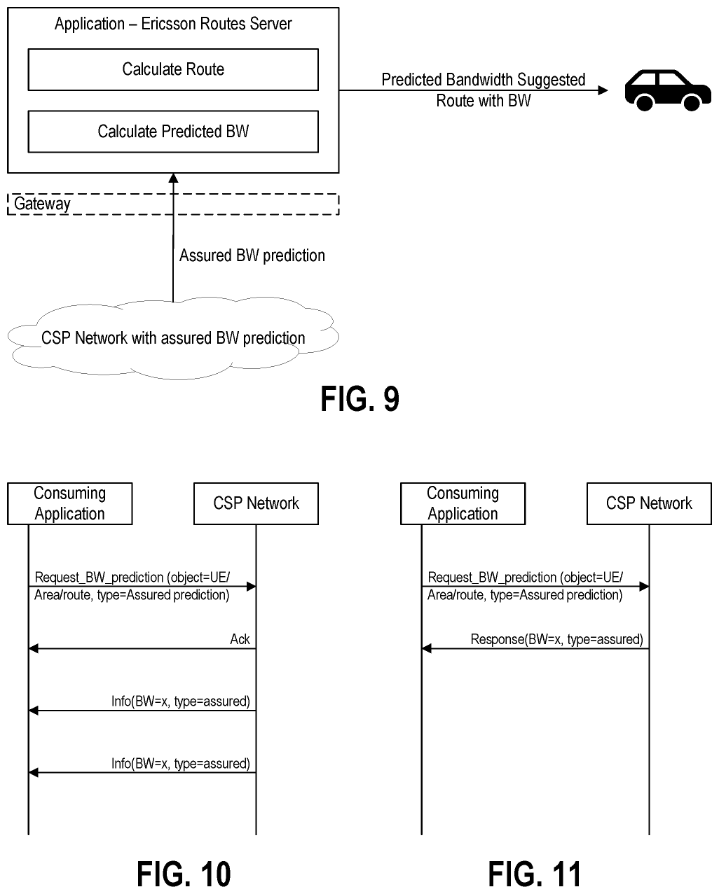

FIG. 9 is a block diagram illustrating an example of a system for assuring bandwidth prediction for a route. In some examples, the application requiring the bandwidth prediction subscribes to the assured bandwidth prediction, indicating that it requires the assured bandwidth prediction.

FIG. 10 is a signal flow diagram illustrating an example of operations performed such that a consuming application can request a subscription to predicted bandwidth for a user, an area, or a route.

FIG. 11 is a signal flow diagram illustrating an example of operations performed such that a consuming application can request a singular request for information of the predicted bandwidth for a user, an area, or a route.

Embodiments associated with prediction classification towards soft intent cost are described below. Some embodiments above have described how an intent is passed to the intent handler, which will collect measurement and take actions towards fulfilling the intent. Some embodiments above have described a soft and conditional intent, that creates the opportunity to define intents based on the situation, based on the measurement received by the system, and the overall goal to ensure a prediction holds true. In some embodiments, it is valuable to only create a soft intent in certain situations based on resource availability and an importance of ensuring the prediction holds true at the time and location.

In some embodiments, an outside agent (e.g., the remote vehicle operator) uses a Route Prediction API to ask the network to find a route between locations A and B where 5 Mbps can be maintained over the next 30 minutes. In some examples, the outside agent can use the Route Prediction API to send the latitude and longitude of the destination it wants to reach. In additional or alternative examples, a route between the current location of the user and the destination can be calculated in terms of max uplink (“UL”) throughput and coverage. For the route selected, a Service Level Indicator that the user can expect can be indicated, which will give the needed information to the remote vehicle operator to know, for example, how many camera's feeds they can upstream for each leg of the route.

In additional or alternative embodiments, each new prediction is like a new SLA stipulated for the specific route and moment in time. Various embodiments herein automate the business decision of how to use resources to fulfill these predictions (e.g., time and location bounded SLA). In some embodiments, one more considerations are taken into account before creating a soft intent to keep a prediction true. In some examples, network measurements or predictions returned by the data collector or prediction algorithm, the current load of the system, and a business criteria/prioritization are taken into account before deciding whether to create a soft intent to keep the prediction true or not. An IBA-capable system not only receives and translates intents that drive selection of action, but can offer additional granularity to decide what to prioritize based on additional information (e.g., a specific user SLA agreement or system load). Compared to known IBA technology, the concept of categories and priorities can help an operator to use system resources according to the real business need.

In some embodiments, the system reads the prediction that is about to be sent to the vehicle operator, categorizes it, and depending on the category takes different actions. In some examples, if the Service Level Indicator is a threshold value above the expected UL throughput needed by the vehicle, the system may do nothing. In additional or alternative examples, if the Service Level Indicator is close (e.g., within a threshold amount) of the Uplink Throughput needed by the vehicle, the system may issue the soft and conditioned intent to protect the service committed/predicted. In additional or alternative examples, if the Service Level Indicator is below (and/or a threshold amount below) what is needed by the vehicle to be operated remotely the system can issue an intent that will prioritize the user traffic for the specific route/time, send an improved SLI value to the vehicle, and issue the soft and conditioned intent to protect the service committed/predicted.

In additional or alternative embodiments, the Communication Service provider can offer differentiated plans to the users of the service creating different tiers for you users (e.g., gold, silver and bronze users) whose predictions are given different levels of certainty of being held true. In additional or alternative embodiments, after the prediction has been calculated, the system will categorize and take different actions based on the plan associated with the user.

In some examples, a top tier user (e.g., a gold user), may get the same treatment as above.

In additional or alternative examples, for a second tier user (e.g., a silver user), when the Service Level Indicator is a threshold amount above the expected UL throughput needed by the vehicle, the system may do nothing. If the Service Level Indicator is close (within a threshold amount) of the Uplink Throughput needed by the vehicle, the system may do nothing. If the Service Level Indicator is below (e.g., a threshold amount below) what is needed by the vehicle to be operated remotely, the system may issue an intent that will prioritize the user traffic for the specific route/time and send an improved SLI value to the vehicle.

In additional or alternative examples, for a third tier user (e.g., a bronze user), the system may do nothing no matter the SLI.

In additional or alternative embodiments, a load of the system (e.g., how many predictions is the system trying to keep true, how many soft intents has the system already dispatched for the same area) can be taken into consideration. Taking into account the load information can increase the possible permutations that the system considers before determining if it should create a soft intent. For example, for a Bronze user, instead of always doing nothing, the system can have additional cases where if the load of the system is low and the system has no other predictions delivered for the specific area, the system can still decide to create a soft intent that would prioritize the user and give the user a better quality of experience overall.

Although the description above is in regard to a three tier classification, the innovations are applicable to any granularity of prioritization of use of system resources. In some examples, how to classify the next best action can be made available to the Operator to configure.

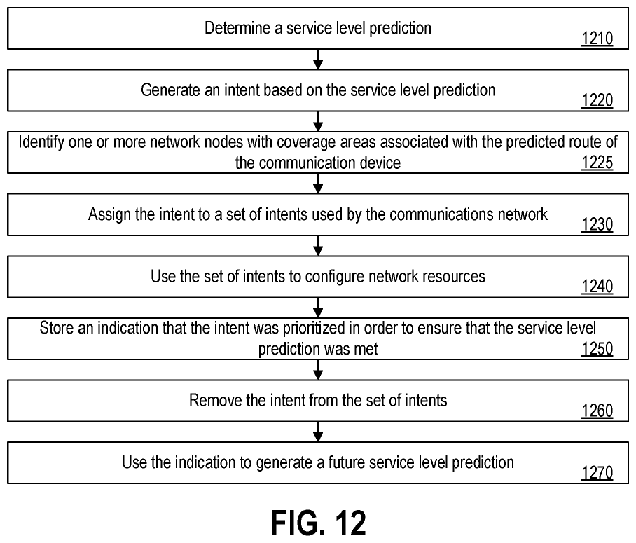

In the description that follows, while the network node may be any of the network node 1610A, 1610B, core network node 1608, network node 1800, virtualization hardware 2004, virtual machines 2008A, 2008B, or network node 2104, the network node 1800 shall be used to describe the functionality of the operations of the network node. Operations of the network node 1800 (implemented using the structure of the block diagram of FIG. 18) will now be discussed with reference to the flow charts of FIGS. 12-14 according to some embodiments of inventive concepts. For example, modules may be stored in memory 1804 of FIG. 18, and these modules may provide instructions so that when the instructions of a module are executed by respective network node processing circuitry 1802, processing circuitry 1802 performs respective operations of the flow chart.

FIG. 12 illustrates operations performed by a network node in a communications network. In some embodiments, the network node includes at least one of: a radio access network, RAN, node; a core network, CN, node; a network orchestrator; a policy control function; a management function; an open-RAN, O-RAN, node; an intent handler; a RAN automation application, a network node hosting rAPP; and a network node hosting an xApp.

At block 1210, processing circuitry 1802 determines a service level prediction. In some embodiments, the service level prediction includes a service level prediction associated with at least one of: a communication device; a geographical area; a coverage area associated with a base station; and a route.

At block 1220, processing circuitry 1802 generates an intent based on the service level prediction. In some embodiments, the service level prediction is associated with a predicted route of a communication device. Generating the intent includes generating the intent to indicate that the communication device be prioritized as long as the communication device moves along the predicted route.

In additional or alternative embodiments, the service level prediction is associated with a first communication device of a plurality of communication devices that are each assigned a service category. The first communication device is assigned to a first service category. The intent includes a soft intent that indicates that the communication device has a higher priority than other communication devices in the first service category and a lower priority than communication devices in a second service category.

In additional or alternative embodiments, generating the intent includes generating the intent based on the service level prediction and a priority of the service level prediction. In some examples, the priority of the service level prediction is predetermined based on at least one of: a difference between an expected throughput and the service level prediction; a category of a service-level agreement associated with a user associated with the service level prediction; a load of the communications network; a priority of the user associated with the service level prediction; and a priority of data associated with the service level prediction.

At block 1225, processing circuitry 1802 identifies one or more network nodes with coverage areas associated with the predicted route of the communication device.

At block 1230, processing circuitry 1802 assigns the intent to a set of intents used by the communications network. In some embodiments, the set of intents are associated with the one or more network nodes that are associated with the service level prediction. For example, if the service level prediction is associated with a predicted route, the set of intents are associated with the one or more network nodes with coverage areas associated with the predicted route of the communication device.

At block 1240, processing circuitry 1802 uses the set of intents to configure network resources. In some embodiments, using the set of intents to configure network resources includes: determining that the service level prediction will not be met; and responsive to determining that the service level prediction will not be met, prioritizing the intent such that the service level prediction is met.

Moreover, the configuring of network resources may include configuring parameters that are typically configured on a slow time scale (e.g., a time scale of seconds or minutes) as well as parameters that are typically configured on a quick time scale (e.g., a time scale of milliseconds or sub-milliseconds), such as momentary resource allocation or scheduling for a specific device.

At block 1250, processing circuitry 1802 stores an indication that the intent was prioritized in order to ensure that the service level prediction was met.

At block 1260, processing circuitry 1802 removes the intent from the set of intents. In some embodiments, the intent is a conditional intent that is only valid until a condition is met. In some examples, the condition includes at least one of: a spatial condition; a temporal condition; and a condition that a predetermined application ends. A predetermined application may end when, for example, a software upgrade download is completed or a file (e.g., video stream) upload is terminated.

At block 1270, processing circuitry 1802 uses the indication to generate a future service level prediction.

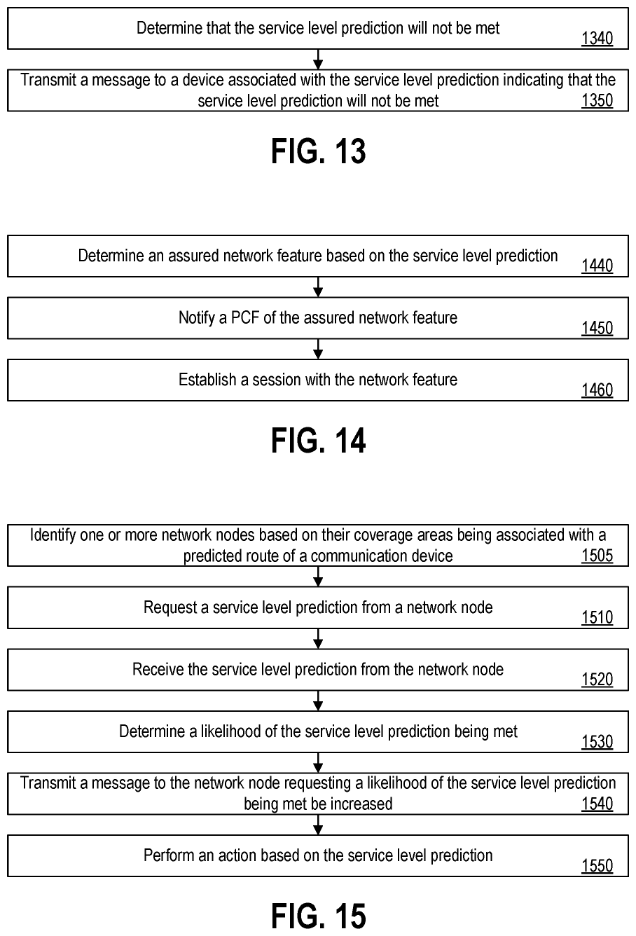

FIG. 13 illustrates an example of operations performed by a network node when a service level prediction will not be met. At block 1340, processing circuitry 1802 determines that the service level prediction will not be met. At block 1350, processing circuitry 1802 transmits, via communication interface 1806, a message to a device associated with the service level prediction indicating that the service level prediction will not be met.

FIG. 14 illustrates an example of operations performed by a communication device to ensure an assured network feature. At block 1440, processing circuitry 1802 determines an assured network feature based on the service level prediction. At block 1450, processing circuitry 1802 notifies, via communication interface 1806, a PCF of the assured network feature. In some examples, the network node is the PCF such that, at block 1460, processing circuitry 1802 ensures a session with the network feature. In some embodiments, the service level prediction includes at least one of: an assured bandwidth; an assured latency; an assured packet loss rate; and an assured basic service availability.

Various operations from the flow charts of FIGS. 12-14 may be optional with respect to some embodiments of network entities and related methods. For examples, in regards to Embodiment 1 below, blocks 1240, 1250, 1260, and 1270 of FIG. 12; blocks 1340 and 1350 of FIG. 13; and blocks 1440, 1450, and 1460 of FIG. 14 may be optional.

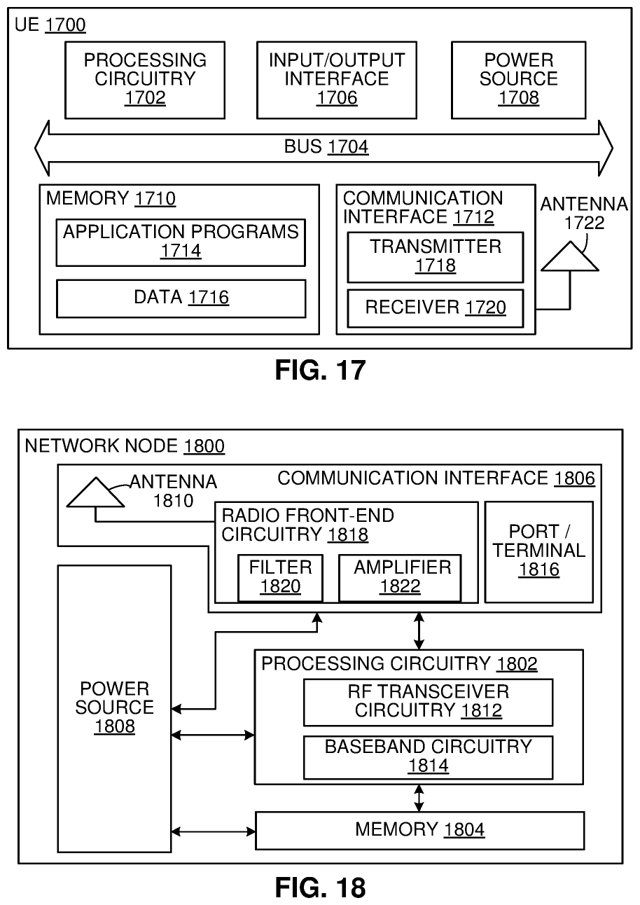

In the description that follows, while the communication device may be any of the wireless device 1612A, 1612B, wired or wireless devices UE 1612C, UE 1612D, UE 1700, virtualization hardware 2004, virtual machines 2008A, 2008B, or UE 2106, the UE 1700 (also referred to herein as communication device 1700) shall be used to describe the functionality of the operations of the communication device. Operations of the communication device 1700 (implemented using the structure of the block diagram of FIG. 17) will now be discussed with reference to the flow chart of FIG. 15 according to some embodiments of inventive concepts. For example, modules may be stored in memory 1710 of FIG. 17, and these modules may provide instructions so that when the instructions of a module are executed by respective communication device processing circuitry 1702, processing circuitry 1702 performs respective operations of the flow chart.

FIG. 15 is flow chart illustrating operations performed by a communication device.

At block 1505, processing circuitry 1702 identifies one or more network nodes based on their coverage areas being associated with the predicted route of the communication device. At block 1510, processing circuitry 1702 requests, via communication interface 1712, a service level prediction from a network node (e.g., one of the one or more network nodes whose coverage area is associated with the predicted route of the communication device). In some embodiments, the network node includes at least one of: a radio access network, RAN, node; a core network, CN, node; a network orchestrator; a policy control function; a management function; an open-RAN, O-RAN, node; an intent handler; a RAN automation application, a network node hosting a rAPP; and a network node hosting an xApp.

At block 1520, processing circuitry 1702 receives, via communication interface 1712, the service level prediction from the network node.

At block 1530, processing circuitry 1702 determines a likelihood of the service level prediction being met. In some embodiments, determining the likelihood of the service level prediction being met includes receiving an indication from the network node that the service level prediction will not be met.

At block 1540, processing circuitry 1702 transmits, via communication interface 1712, a message to the network node requesting a likelihood of the service level prediction being met be increased.

At block 1550, processing circuitry 1702 performs an action based on the service level prediction. In some embodiments, the network node is a first network node of a first communications network. Performing the action based on the service level prediction includes: responsive to determining the likelihood of the service level prediction being met, disconnecting from the first network node; and connecting to a second network node of a second communications network.

In additional or alternative embodiments, the service level prediction is associated with a predicted route of the communication device. Performing the action based on the service level prediction includes at least one of: moving along the route; and adjusting the route based on the likelihood of the service level prediction being met.

Various operations from the flow chart of FIG. 15 may be optional with respect to some embodiments of network entities and related methods. For example, in regards to Example Embodiment 17, blocks 1540 and 1550 of FIG. 15 may be optional.

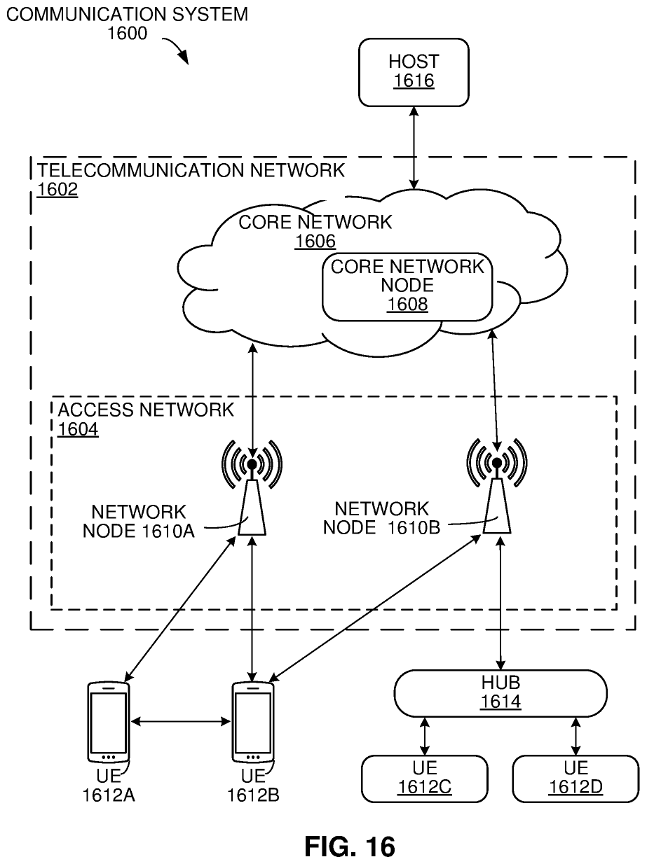

FIG. 16 shows an example of a communication system 1600 in accordance with some embodiments.

In the example, the communication system 1600 includes a telecommunication network 1602 that includes an access network 1604, such as a radio access network (RAN), and a core network 1606, which includes one or more core network nodes 1608. The access network 1604 includes one or more access network nodes, such as network nodes 1610a and 1610b (one or more of which may be generally referred to as network nodes 1610), or any other similar 3^{rd} Generation Partnership Project (3GPP) access node or non-3GPP access point. Moreover, as will be appreciated by those of skill in the art, the network nodes 1610 are not necessarily limited to an implementation in which a radio portion and a baseband portion are supplied and integrated by a single vendor. Thus, it will be understood that the network nodes 1610 may include disaggregated implementations or portions thereof. For example, in some embodiments, the telecommunication network 1602 includes one or more Open-RAN (ORAN) network nodes. An ORAN network node is a node in the telecommunication network 1602 that supports an ORAN specification (e.g., a specification published by the O-RAN Alliance, or any similar organization) and may operate alone or together with other nodes to implement one or more functionalities of any node in the telecommunication network 1602, including one or more network nodes 1610 and/or core network nodes 1608.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. The intents described herein, including soft and conditional intents, may be communicated from a 3GPP network node or an ORAN network node over 3GPP-defined interfaces (e.g., N2, N3) or ORAN Alliance-defined interfaces (e.g., A1, O1).

Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 1610 facilitate direct or indirect connection of user equipment (UE), such as by connecting wireless devices 1612a, 1612b, 1612c, and 1612d (one or more of which may be generally referred to as UEs 1612) to the core network 1606 over one or more wireless connections. The network nodes 1610 facilitate direct or indirect connection of user equipment (UE), such as by connecting UEs 1612a, 1612b, 1612c, and 1612d (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602, and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1602 is a cellular network that implements 3GPP standardized features. Accordingly, the telecommunications network 1602 may support network slicing to provide different logical networks to different devices that are connected to the telecommunication network 1602. For example, the telecommunications network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1614 communicates with the access network 1604 to facilitate indirect communication between one or more UEs (e.g., UE 1612c and/or 1612d) and network nodes (e.g., network node 1610b). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a VR headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular in if one or more of the UEs are low energy IoT devices.

The hub 1614 may have a constant/persistent or intermittent connection to the network node 1610b. The hub 1614 may also allow for a different communication scheme and/or schedule between the hub 1614 and UEs (e.g., UE 1612c and/or 1612d), and between the hub 1614 and the core network 1606. In other examples, the hub 1614 is connected to the core network 1606 and/or one or more UEs via a wired connection. Moreover, the hub 1614 may be configured to connect to an M2M service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub—that is, a hub whose primary function is to route communications to/from the UEs from/to the network node 1610b. In other embodiments, the hub 1614 may be a non-dedicated hub—that is, a device which is capable of operating to route communications between the UEs and network node 1610b, but which is additionally capable of operating as a communication start and/or end point for certain data channels.

FIG. 17 shows a UE 1700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, a memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1702 may include multiple central processing units (CPUs).

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging of the power source 1708. Power circuitry may perform any formatting, converting, or other modification to the power from the power source 1708 to make the power suitable for the respective components of the UE 1700 to which power is supplied.

The memory 1710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1710 may allow the UE 1700 to access instructions, application programs and the like, stored on transitory or non-transitory memory media, to off-load data, or to upload data. An article of manufacture, such as one utilizing a communication system may be tangibly embodied as or in the memory 1710. which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., antenna 1722) and may share circuit components, software or firmware, or alternatively be implemented separately.

In the illustrated embodiment, communication functions of the communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 18 shows a network node 1800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes a processing circuitry 1802, a memory 1804, a communication interface 1806, and a power source 1808. The network node 1800 may be composed of multiple physically separate components (e.g., a NodeB component and a RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1800 may be configured to support multiple radio access technologies (RATs). In such embodiments, some components may be duplicated (e.g., separate memory 1804 for different RATs) and some components may be reused (e.g., a same antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1800.

The processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as the memory 1804, to provide network node 1800 functionality.

In some embodiments, the processing circuitry 1802 includes a system on a chip (SOC). In some embodiments, the processing circuitry 1802 includes one or more of radio frequency (RF) transceiver circuitry 1812 and baseband processing circuitry 1814. In some embodiments, the radio frequency (RF) transceiver circuitry 1812 and the baseband processing circuitry 1814 may be on separate chips (or sets of chips), boards, or units, such as radio units and digital units. In alternative embodiments, part or all of RF transceiver circuitry 1812 and baseband processing circuitry 1814 may be on the same chip or set of chips, boards, or units.

The memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and memory 1804 is integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. Radio front-end circuitry 1818 comprises filters 1820 and amplifiers 1822. The radio front-end circuitry 1818 may be connected to an antenna 1810 and processing circuitry 1802. The radio front-end circuitry may be configured to condition signals communicated between antenna 1810 and processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of filters 1820 and/or amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface may comprise different components and/or different combinations of components.

In certain alternative embodiments, the network node 1800 does not include separate radio front-end circuitry 1818, instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes one or more ports or terminals 1816, the radio front-end circuitry 1818, and the RF transceiver circuitry 1812, as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, communication interface 1806, and/or the processing circuitry 1802 may be configured to perform any receiving operations and/or certain obtaining operations described herein as being performed by the network node. Any information, data and/or signals may be received from a UE, another network node and/or any other network equipment. Similarly, the antenna 1810, the communication interface 1806, and/or the processing circuitry 1802 may be configured to perform any transmitting operations described herein as being performed by the network node. Any information, data and/or signals may be transmitted to a UE, another network node and/or any other network equipment.

The power source 1808 provides power to the various components of network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid, an electricity outlet) via an input circuitry or interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

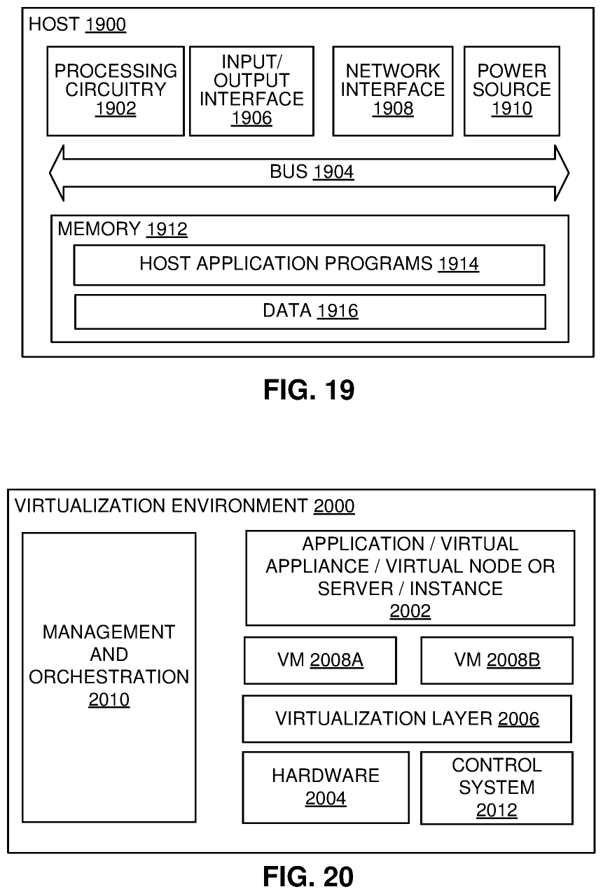

FIG. 19 is a block diagram of a host 1900, which may be an embodiment of the host 1616 of FIG. 16, in accordance with various aspects described herein. As used herein, the host 1900 may be or comprise various combinations hardware and/or software, including a standalone server, a blade server, a cloud-implemented server, a distributed server, a virtual machine, container, or processing resources in a server farm. The host 1900 may provide one or more services to one or more UEs.

The host 1900 includes processing circuitry 1902 that is operatively coupled via a bus 1904 to an input/output interface 1906, a network interface 1908, a power source 1910, and a memory 1912. Other components may be included in other embodiments. Features of these components may be substantially similar to those described with respect to the devices of previous figures, such as FIGS. 17 and 18, such that the descriptions thereof are generally applicable to the corresponding components of host 1900.

The memory 1912 may include one or more computer programs including one or more host application programs 1914 and data 1916, which may include user data, e.g., data generated by a UE for the host 1900 or data generated by the host 1900 for a UE. Embodiments of the host 1900 may utilize only a subset or all of the components shown. The host application programs 1914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1914 may also provide for user authentication and licensing checks and may periodically report health, routes, and content availability to a central node, such as a device in or on the edge of a core network. Accordingly, the host 1900 may select and/or indicate a different host for over-the-top services for a UE. The host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 2000 includes components defined by the O-RAN Alliance, such as an O-Cloud environment orchestrated by a Service Management and Orchestration Framework via an O-2 interface.

Applications 2002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2006 (also referred to as hypervisors or virtual machine monitors (VMMs)), provide VMs 2008a and 2008b (one or more of which may be generally referred to as VMs 2008), and/or perform any of the functions, features and/or benefits described in relation with some embodiments described herein. The virtualization layer 2006 may present a virtual operating platform that appears like networking hardware to the VMs 2008.

The VMs 2008 comprise virtual processing, virtual memory, virtual networking or interface and virtual storage, and may be run by a corresponding virtualization layer 2006. Different embodiments of the instance of a virtual appliance 2002 may be implemented on one or more of VMs 2008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2008 may be a software implementation of a physical machine that runs programs as if they were executing on a physical, non-virtualized machine. Each of the VMs 2008, and that part of hardware 2004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2008 on top of the hardware 2004 and corresponds to the application 2002.

Hardware 2004 may be implemented in a standalone network node with generic or specific components. Hardware 2004 may implement some functions via virtualization. Alternatively, hardware 2004 may be part of a larger cluster of hardware (e.g. such as in a data center or CPE) where many hardware nodes work together and are managed via management and orchestration 2010, which, among others, oversees lifecycle management of applications 2002. In some embodiments, hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2012 which may alternatively be used for communication between hardware nodes and radio units.

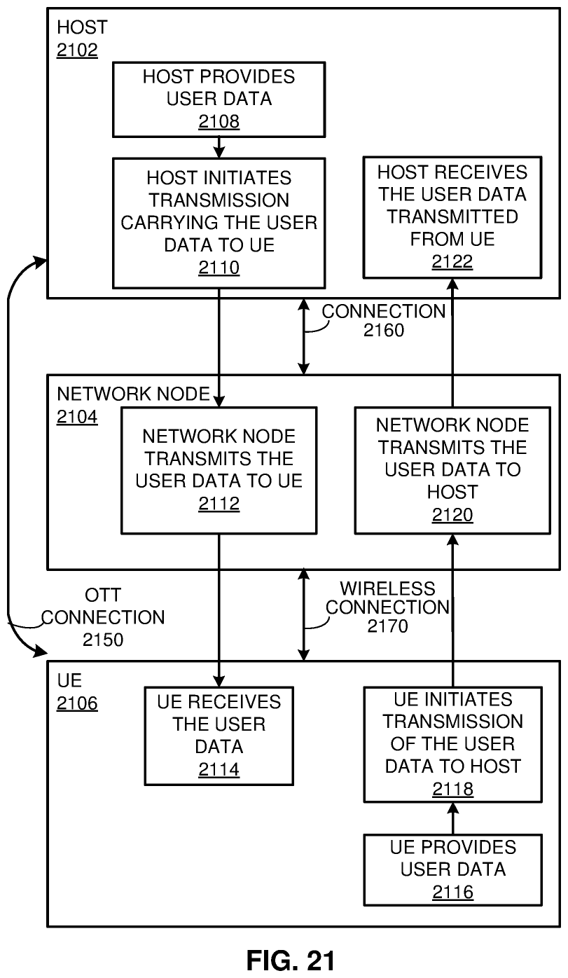

FIG. 21 shows a communication diagram of a host 2102 communicating via a network node 2104 with a UE 2106 over a partially wireless connection in accordance with some embodiments. Example implementations, in accordance with various embodiments, of the UE (such as a UE 1612a of FIG. 16 and/or UE 1700 of FIG. 17), network node (such as network node 1610a of FIG. 16 and/or network node 1800 of FIG. 18), and host (such as host 1616 of FIG. 16 and/or host 1900 of FIG. 19) discussed in the preceding paragraphs will now be described with reference to FIG. 21.

Like host 1900, embodiments of host 2102 include hardware, such as a communication interface, processing circuitry, and memory. The host 2102 also includes software, which is stored in or accessible by the host 2102 and executable by the processing circuitry. The software includes a host application that may be operable to provide a service to a remote user, such as the UE 2106 connecting via an over-the-top (OTT) connection 2150 extending between the UE 2106 and host 2102. In providing the service to the remote user, a host application may provide user data which is transmitted using the OTT connection 2150.

The network node 2104 includes hardware enabling it to communicate with the host 2102 and UE 2106. The connection 2160 may be direct or pass through a core network (like core network 1606 of FIG. 16) and/or one or more other intermediate networks, such as one or more public, private, or hosted networks. For example, an intermediate network may be a backbone network or the Internet.

The UE 2106 includes hardware and software, which is stored in or accessible by UE 2106 and executable by the UE's processing circuitry. The software includes a client application, such as a web browser or operator-specific “app” that may be operable to provide a service to a human or non-human user via UE 2106 with the support of the host 2102. In the host 2102, an executing host application may communicate with the executing client application via the OTT connection 2150 terminating at the UE 2106 and host 2102. In providing the service to the user, the UE's client application may receive request data from the host's host application and provide user data in response to the request data. The OTT connection 2150 may transfer both the request data and the user data. The UE's client application may interact with the user to generate the user data that it provides to the host application through the OTT connection 2150.

The OTT connection 2150 may extend via a connection 2160 between the host 2102 and the network node 2104 and via a wireless connection 2170 between the network node 2104 and the UE 2106 to provide the connection between the host 2102 and the UE 2106. The connection 2160 and wireless connection 2170, over which the OTT connection 2150 may be provided, have been drawn abstractly to illustrate the communication between the host 2102 and the UE 2106 via the network node 2104, without explicit reference to any intermediary devices and the precise routing of messages via these devices.

As an example of transmitting data via the OTT connection 2150, in step 2108, the host 2102 provides user data, which may be performed by executing a host application. In some embodiments, the user data is associated with a particular human user interacting with the UE 2106. In other embodiments, the user data is associated with a UE 2106 that shares data with the host 2102 without explicit human interaction. In step 2110, the host 2102 initiates a transmission carrying the user data towards the UE 2106. The host 2102 may initiate the transmission responsive to a request transmitted by the UE 2106. The request may be caused by human interaction with the UE 2106 or by operation of the client application executing on the UE 2106. The transmission may pass via the network node 2104, in accordance with the teachings of the embodiments described throughout this disclosure. Accordingly, in step 2112, the network node 2104 transmits to the UE 2106 the user data that was carried in the transmission that the host 2102 initiated, in accordance with the teachings of the embodiments described throughout this disclosure. In step 2114, the UE 2106 receives the user data carried in the transmission, which may be performed by a client application executed on the UE 2106 associated with the host application executed by the host 2102.

In some examples, the UE 2106 executes a client application which provides user data to the host 2102. The user data may be provided in reaction or response to the data received from the host 2102. Accordingly, in step 2116, the UE 2106 may provide user data, which may be performed by executing the client application. In providing the user data, the client application may further consider user input received from the user via an input/output interface of the UE 2106. Regardless of the specific manner in which the user data was provided, the UE 2106 initiates, in step 2118, transmission of the user data towards the host 2102 via the network node 2104. In step 2120, in accordance with the teachings of the embodiments described throughout this disclosure, the network node 2104 receives user data from the UE 2106 and initiates transmission of the received user data towards the host 2102. In step 2122, the host 2102 receives the user data carried in the transmission initiated by the UE 2106.

One or more of the various embodiments improve the performance of OTT services provided to the UE 2106 using the OTT connection 2150, in which the wireless connection 2170 forms the last segment. More precisely, the teachings of these embodiments may use the concept of “soft and conditioned intents,” to improve IBA systems. In some examples, the use of soft and conditioned intents extends the applicability of IBA to use-cases that require greater stabilization of performance and predictability. In additional or alternative examples, the use of soft and conditioned intents makes it possible to use IBA to more precisely stabilize performance within a priority group without significant impact on other priority groups.

In an example scenario, factory status information may be collected and analyzed by the host 2102. As another example, the host 2102 may process audio and video data which may have been retrieved from a UE for use in creating maps. As another example, the host 2102 may collect and analyze real-time data to assist in controlling vehicle congestion (e.g., controlling traffic lights). As another example, the host 2102 may store surveillance video uploaded by a UE. As another example, the host 2102 may store or control access to media content such as video, audio, VR or AR which it can broadcast, multicast or unicast to UEs. As other examples, the host 2102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2150 between the host 2102 and UE 2106, in response to variations in the measurement results. The measurement procedure and/or the network functionality for reconfiguring the OTT connection may be implemented in software and hardware of the host 2102 and/or UE 2106. In some embodiments, sensors (not shown) may be deployed in or in association with other devices through which the OTT connection 2150 passes; the sensors may participate in the measurement procedure by supplying values of the monitored quantities exemplified above, or supplying values of other physical quantities from which software may compute or estimate the monitored quantities. The reconfiguring of the OTT connection 2150 may include message format, retransmission settings, preferred routing etc.; the reconfiguring need not directly alter the operation of the network node 2104. Such procedures and functionalities may be known and practiced in the art. In certain embodiments, measurements may involve proprietary UE signaling that facilitates measurements of throughput, propagation times, latency and the like, by the host 2102. The measurements may be implemented in that software causes messages to be transmitted, in particular empty or ‘dummy’ messages, using the OTT connection 2150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example. non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method of operating a network node in a communications network, the method comprising:
determining a service level prediction;
generating an intent based on the service level prediction; and
assigning the intent to a set of intents used by the communications network.

2. The method of claim 1, wherein the service level prediction comprises a service level prediction associated with at least one of:
a communication device;
a geographical area;
a coverage area associated with a base station; and
a route.

3. The method of claim 1, wherein the intent comprises a conditional intent that is only valid until a condition is met, the method further comprising:
responsive to determining that the condition is met, removing the intent from the set of intents.

4. The method of claim 3, wherein the condition comprises at least one of:
a spatial condition;
a temporal condition; and
a condition that a predetermined application ends.

5. The method of claim 1, wherein the service level prediction is associated with a predicted route of a communication device, and wherein generating the intent comprises generating the intent to indicate that the communication device be prioritized as long as the communication device moves along the predicted route.

6. The method of claim 5, further comprising:
identifying one or more network nodes with coverage areas associated with the predicted route of the communication device, wherein the set of intents are associated with the one or more network nodes.

7. The method of claim 1, wherein the service level prediction is associated with a first communication device of a plurality of communication devices that are each assigned a service category;
wherein the first communication device is assigned to a first service category; and
wherein the intent comprises a soft intent that indicates that the communication device have a higher priority than other communication devices in the first service category and a lower priority than communication devices in a second service category.

8. The method of claim 1, further comprising:
determining that the service level prediction will not be met; and
responsive to determining that the service level prediction will not be met, transmitting a message to a device associated with the service level prediction indicating that the service level prediction will not be met.

9. The method of claim 1, wherein the service level prediction comprises at least one of:
an assured bandwidth;
an assured latency;
an assured packet loss rate; and
an assured basic service availability.

10. The method of claim 1, wherein the service level prediction comprises the assured bandwidth, the method further comprising:
determining an assured bandwidth value based on the service level prediction; and
notifying a Policy Control Function, PCF, in the communications network of the assured bandwidth value.

11. (canceled)

12. The method of claim 1, wherein generating the intent comprises generating the intent based on the service level prediction and a priority of the service level prediction.

13. (canceled)

14. (canceled)

15. The method of claim 1, further comprising:
using the set of intents to configure network resources.

16. The method of claim 15, wherein using the set of intents to configure network resources comprises:
determining that the service level prediction will not be met; and
responsive to determining that the service level prediction will not be met, prioritizing the intent such that the service level prediction is met.

17. (canceled)

18. A method of operating a communication device in a communications network, the method comprising:
requesting a service level prediction from a network node in the communications network;
receiving the service level prediction from the network node; and
performing an action based on the service level prediction.

19. The method of claim 18, further comprising:
transmitting a message to the network node requesting a likelihood of the service level prediction being met be increased.

20. The method of claim 18, further comprising:
determining a likelihood of the service level prediction being met.

21. (canceled)

22. The method of claim 20, wherein the network node is a first network node of a first communications network, and wherein performing the action based on the service level prediction comprises:
responsive to determining the likelihood of the service level prediction being met, disconnecting from the first network node; and
connecting to a second network node of a second communications network.

23. The method of claim 18, wherein the service level prediction is associated with a predicted route of the communication device, wherein performing the action based on the service level prediction comprises at least one of:
moving along the route; and
adjusting the route based on the likelihood of the service level prediction being met.

24. (canceled)

25. (canceled)

26. A network node operating in a communications network, the network node comprising:
processing circuitry; and
memory coupled to the processing circuitry and having instructions stored therein that are executable by the processing circuitry to cause the communication device to:
determine a service level prediction;
generate an intent based on the service level prediction; and
assign the intent to a set of intents used by the communications network.

27-29. (canceled)

30. A communication device operating in a communications network, the network node comprising:
processing circuitry; and
memory coupled to the processing circuitry and having instructions stored therein that are executable by the processing circuitry to cause the communication device to:
request a service level prediction from a network node in the communications network;
receive the service level prediction from the network node; and
perform an action based on the service level prediction.

31-33. (canceled)
